(19) United States
(12) Patent Application Publication
(10) Pub. No.: US 2026/0148559 A1
(43) Pub. Date: May 28, 2026

(54) ITEM IMAGE LIBRARY MAINTENANCE BASED ON LOW-QUALITY IMAGES

(71) Applicant: Home Depot Product Authority, LLC, Atlanta, GA (US)

(72) Inventors: Hari Ramamurthy, Marietta, GA (US); Bodhisatta Maiti, Orlando, FL (US); Akshay Kumar, Chicago, IL (US); Dhruv Narayan, Miami Beach, FL (US); Deepak Kumar Arumugam, Smyrna, GA (US); Michael Carpenter, Johns Creek, GA (US); Muzammil Akram, Marietta, GA (US); Chris Black, Decatur, GA (US)

(21) Appl. No.: 18/960,394

(22) Filed: Nov. 26, 2024

(51) Int. Cl. G06V 20/52; G06F 16/51; G08B 23/00; H04N 7/18

(52) U.S. Cl. CPC G06V 20/52; G06F 16/51; G08B 23/00; H04N 7/18; G06V 2201/07

(57) ABSTRACT

A method includes receiving a new image of an item based on a time-stamped user interaction with the item, applying object detection to the new image to identify the item, determining a respective similarity of the image to each old image of the item in a library of old images, and adding the new image to the library only if each respective similarity is below a similarity threshold.

### TECHNICAL FIELD

The present disclosure generally relates to the generation and use of item image libraries for item detection in live video feeds and other images.

### BRIEF DESCRIPTION OF THE DRAWINGS

FIG. 1 is a block diagram view of an example system for building and applying an item image library.

FIG. 2 is a flow chart illustrating an example method of building and applying an item image library.

FIG. 3 is a flow chart illustrating an example method of building an item image library.

FIG. 4 is a diagrammatic view of an example embodiment of a user computing environment.

### DETAILED DESCRIPTION

On-premises security systems may use surveillance cameras and real-time (or near-real-time) analysis of footage to ensure that items are not permitted into or out of a facility without permission. For example, such image analysis may be used to prevent unauthorized removal of packaged or unpackaged items from a facility (e.g., confidential items, items that must be purchased to be removed, and so on). Further, such image analysis may be used to prevent unauthorized entry of dangerous or forbidden items into a facility.

Image comparison-based security systems necessarily rely on one or more basis images for identification of items in real-time video footage. As a result, building a diverse set of images of acceptable quality of each item to be detected is important for a robust item detection system.

Furthermore, continuously analyzing frames of a video feed for items to be detected can require a large amount of computing power. As a result, triggering video frame analysis according to item scans or other user/item interactions as disclosed herein enables a robust system with reduced processing workload.

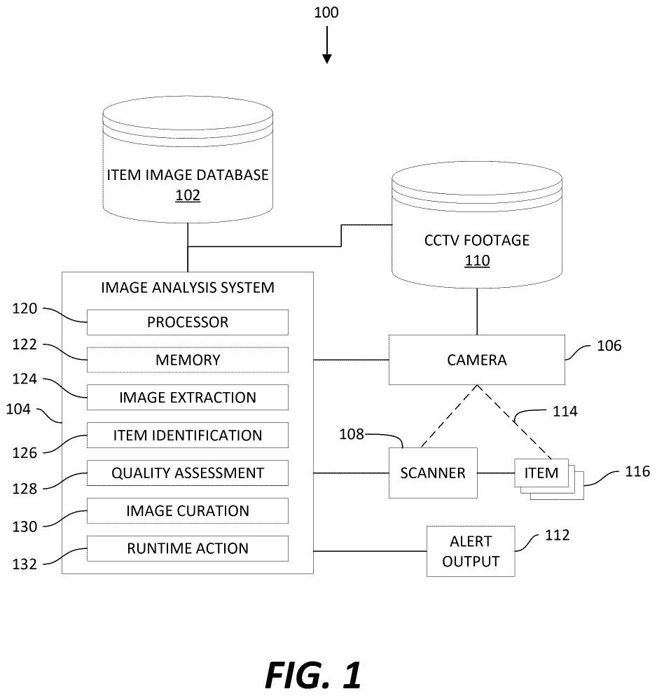

Referring to the drawings, wherein like numerals refer to the same or similar features in the various views, FIG. 1 is a block diagram view of a system 100 for building and applying an item image library. The system includes an item image database 102, an image analysis system 104, a camera 106, a scanner 108, a database 110 of closed circuit television (CCTV) footage or other footage from the camera and/or other cameras, and an alert output 112.

In general, the system 100 may be deployed at a facility in order to prevent unauthorized removal or introduction of particular items from or to the facility. For example, the system 100 may be deployed at a warehouse, a retail facility, a secured-access facility, and the like. As will be described in more detail below, the system 100 may be used to build a library of images (e.g., from scratch or by supplementing a pre-existing library) of items to be detected to prevent removal/introduction of those items, for real-time detection and identification of such items and responsive action in association with detection and identification.

The item image database 102 may include a library having a plurality of images of a plurality of items. For a given item, the multiple images of the item may be from different angles or perspectives, under different lighting or shadow conditions, with different portions of the item showing and obscured, and with one or more cosmetic differences in the item itself or the item's packaging or tagging. The item image database 102 may include, for a given item, a plurality of images captured by cameras in a security context (as opposed to images of the item captured in a dedicated photo shoot or other controlled setting), such as by the camera 106 or similarly-situated cameras. The items having associated images in the item image database may be a plurality of items the movement of which into or out of a facility is to be controlled. For example, in a retail context, the items may be items offered for sale in the retail facility. In a warehouse context, the items may be items that are often stored in the warehouse. In a controlled-checkout facility (e.g., facility with confidential objects that must be checked out), the items may be the objects that must be checked out. In these same contexts or other contexts, the items may be items prohibited from entry into the facility.

In addition to images of items, the item image database 102 may store a respective embeddings vector representative of each item image, or another representation that is readable and/or processable by a machine learning model or other set of algorithms.

The camera 106 may be one or more cameras disposed at a controlled location, such as a check-in or check-out and/or proximate an entry or exit of the facility. The camera 106 may be a closed-circuit television (CCTV) camera, for example, that produces low quality images relative to available camera technology (e.g., to reduce the bandwidth, processing, electronic storage, and up-front cost required for the camera). For example, the camera 106 may produce a video stream having a resolution of 1920×1080 or less. The camera 106 may be in a fixed position in the facility (e.g., may be mounted to the building), in some embodiments. As used herein, a fixed position encompasses a camera that is mounted so as to permit rotation or pivoting of the camera to shift its field of view, without otherwise changing the position of the camera with respect to the facility. Accordingly, a fixed position camera may be a rotatable or pivotable camera, or may be both positionally and pivotally/rotationally fixed, in various embodiments. The camera may be placed approximately 10 feet above the ground, in some embodiments.

The scanner 108 may be or may include one or more devices for scanning items, or labels on items, to identify those items. The scanner 108 may include, for example, an optical scanner such as a bar code scanner or a QR code scanner. Additionally or alternatively, the scanner 108 may include an electromagnetic reader such as a near-field communications (NFC) reader or RFID tag reader. The scanner 108 may read labels or tags, and such a reading may be recorded and time-stamped. The scanner 108 may be disposed within a field of view 114 of the camera 106. The time stamp of a scan may serve as a basis for analyzing one or more frames of video from the camera 106, as such a scan may indicate that one or more items 116 are also within the field of view 114 of the camera 106. Additionally, the scan may positively identify the scanned item 116, which scan-based identification may serve as ground truth information for the scanned item 116 to confirm item information that may be determined based on the video captured by the camera 106, among other purposes.

The scanner 108 may include both a physical scanning device (e.g., sensors and supporting hardware) as well as a supporting computing system that receives and interprets the scan, applies a time stamp, associates the scan with a particular location, physical scanning device, determines the identity of the item scanned (or individual, where the scanner 108 scans an access badge or other personal identification) and that communicates with the image analysis system 104.

The database of CCTV footage 110 may include previously-captured video feeds from the camera 106 and/or other cameras. The database of CCTV footage 110 may be separate from the storage of and use of a video feed from the camera 106 by the image analysis system 104, in embodiments. For example, the stream from the camera 106 may be separately transmitted to the database of CCTV footage 110 and to the image analysis system 104. In other embodiments, the image analysis system 104 may recall video from and search the database of CCTV footage 110. In such embodiments, the stream of video captured by the camera 106 may be accessed or received by the image analysis system 104 via the database of CCTV footage 110.

The image analysis system 104 may be in electronic communication with the camera 106, the scanner 108, the item image database 102, and/or the database of CCTV footage 110. As will be described in more detail below, the image analysis system 104 may build, curate, and/or supplement the image library in the item image database 102, and/or utilize the library for real-time item access control into and/or out of a facility or to identify items in video captured by the camera 106 for other purposes.

The item analysis system 104 may include a processor 120 and a non-transitory, computer-readable memory 122 storing instructions that, when executed by the processor 120, cause the image analysis system 104 to perform one or more of the actions, methods, operations, algorithms, etc. of this disclosure.

The image analysis system 104 may include a plurality of functional modules 124, 126, 128, 130, 132 that may be implemented as hardware and/or software. For example, each of the functional modules 124, 126, 128, 130, 132 may be implemented as instructions stored in the memory 122, in some embodiments.

The image analysis system 104 may include an image extraction module 124 configured to receive a video stream captured by the camera 106 and extract one or more frames (e.g., still images) from the video stream. The image extraction module 124 may isolate frames for extraction according to scan data received from the scanner 108. For example, each scan of an item by the scanner may be time-stamped, and each frame of the received video feed may be time-stamped. The image extraction module 124 may extract one or more frames closest in time to a scan, based on the time stamps of the frames and the time stamp of the scan, in some embodiments.

The image analysis system 104 may further include an item identification module 126 configured to receive an image (e.g., an image, such as a video frame isolated from a video stream by the image extraction module 124) and to detect and identify one or more items in the image. The image identification module 126 may, for example, apply one or more object detection algorithms to the image to detect one or more items and to generate a bounding box around each detected item. Portions of the image within a bounding box may be treated as a new item image for further processing, in some embodiments.

The item identification module 126 may further be configured to determine a specific item included in a new item image. For example, the item identification module may generate an embeddings vector representative of the new item image and compare the embeddings vector to embeddings vectors stored in the item image database 102. If the embeddings vector respective of the new item image under consideration is sufficiently similar to an embeddings vector stored in the item image database 102, the item identification module 126 may conclude that the two images are of the same item (i.e., may identify the item in the new item image).

In some embodiments, the item identification module 126 may determine a plurality of specific items in a given image. That is, the item identification module 126 may detect multiple new item images within a given image as described above, and may then identify the item in each of those new item images, also as described above. For example, where a user carries multiple items in a cart or on another platform at a facility and then scans one of those items with the scanner 108, a still image from video captured by the camera 106 may include the cart and all items in the cart, and thus each item in the cart that is visible may be detected in the image and identified by the item identification module 126.

The image analysis system 104 may further include a quality assessment module 128 that applies one or more image processing techniques to a new item image to improve the quality of the image and/or to calculate a quality score value that may be analyzed to determine whether to store and use or discard a new item image. For example, the quality assessment module 128 may apply one or more of a variance of Laplacian (VOL) analysis, a Contrast Limited Adaptive Histogram Equalization (CLAHE) optimization, a CLIP image quality assessment (CLIP-IQA), and/or one or more other image enhancement or processing techniques. New item images of sufficiently high quality may be considered for addition to the item image database 102 and/or for runtime action.

The image analysis system 104 may include an image curation module 130 configured to determine whether or not to add a new item image to the item image database 102 and/or to remove images from the item image database 102. The image curation module 130 may, for example, utilize a quality score calculated by the quality assessment module 128 and compare the quality score to a quality threshold. Additionally or alternatively, the image curation module 130 may determine whether or not to add a new item image to the item image library based on its similarity to existing item images. For example, the image curation module 130 may generate an embeddings vector respective of the new item image (or use a previously-generated vector) and compare that embeddings vector to embeddings vectors of all other images of the same item stored in the image library. If the new item image is sufficiently dissimilar from the existing images of the same item, that may indicate that the new item image adds variety and depth to the images of the item, and thus the new item image may be considered for addition to the item image database 102.

The image curation module 130 may also consider a quantity of images of a given item stored in the item image database 102, and may be configured to maintain a quantity of images that is below a maximum threshold and above a minimum threshold for a given item. The maximum and minimum thresholds may be selected to ensure a sufficient diversity and variety of images of the item without unduly imposing processing and storage burden. For example, the image curation module 130 may ensure that the item image database 102 has more than 100 images for each item, in some embodiments, or between 200 and 250 images for each item, in some embodiments. To maintain a minimum quantity of images, the image curation module 130 may cause all new item images of an item to be added to the item image database 102 until the minimum threshold for the item is reached, irrespective of similarity to other stored images (though a minimum image quality may be enforced or required). Once a maximum quantity of images is reached for an item, the image curation module 130 may prevent further images of the item from being added, or may replace an existing image in the database 102 with a new image that is higher quality or that results in greater image variety or diversity of the item.

The image analysis system 104 may further include a runtime action module 132 configured to receive new item images and/or item identifications and determine if unauthorized items are being introduced to and/or removed from the facility in which the system 100 is deployed. The runtime action module 132 may compare a list of items identified in one or more images by the item identification module 126 to a list of items authorized for (or forbidden for) removal and/or introduction to/from the facility. For example, where the system 100 is deployed in a retail location, the runtime action module 132 may compare the list of identified items to a list of items scanned at a checkout. If an item has been identified in one or more images and has not been scanned, the user may have accidentally neglected to scan the item, and the runtime action module 132 may cause an alert to be output via an alert output mechanism 112.

The alert output mechanism 112 may be or may include, for example, a light near the scanner 108, a speaker near the scanner 108, an output on a graphical interface with which the user interacts, and/or a device held by or accessible to personnel near the scanner 108. For example, when an alert is to be generated and output, the alert may be intended to alert nearby personnel, who can then assist the user in completing scanning of items, confirm the user's possession of unscanned items, etc. In another example, when the user completes scanning items, the alert may be an output to the user on a display that prompts the user to ensure that all items have been scanned, and/or indicating that not all items have been scanned.

In a first example, the system 100 may be deployed in a retail facility or other facility with a controlled inventory, such as a warehouse, evidence locker, supply closet, etc. A user may bring a cart or other combination of items to a checkout area with a bar code scanner or other scanner 108. A CCTV camera 106 may be located in a fixed position above the checkout area, with the scanner 108 and adjacent area (where the cart will likely be placed) within the field of view 114 of the camera 106. When the user scans a first item, the image analysis system 104 may receive the scan information, including the identity of the item scanned and a time stamp of the scan. The image analysis system 104 may then retrieve the stream of video near the time stamp and isolate one or more frames closest in time to the time stamp. In each isolated frame, the image analysis system 104 may detect and identify one or more items (e.g., each item identifiable in each image). The image analysis system 104 may repeat this process for each scan by the user.

Once the image analysis system 104 determines that the user has stopped scanning items (e.g., when a predetermined amount of time has passed since a most recent scan, when a user ends the checkout process through a graphical interface, etc.), the image analysis system 104 may compare the list of items identified in the isolated images to a list of items scanned by the user based on the scan information. If the image analysis system 104 determines that the user possessed one or more items that were not scanned, the image analysis system 104 may output an alert through an alert output mechanism 112 (e.g., through multiple such mechanisms, such as an alert to the user on an interface and an alert to facility personnel on an interface utilized by the facility personnel). In some embodiments, the facility personnel may respond to the alert by confirming or correcting, via a user computing device, the conclusions made by the image analysis system 104 as to the items possessed by the user. Additionally or alternatively, the alert may be an automated action, such as causing an access door to be locked, adding an unchecked item to a user's checkout list, etc.

The image analysis system 104 may also consider each new item image in each isolated frame for addition to the item image library in the item image database 102. For each new item image, the image analysis system 104 may determine whether the image is of sufficiently high quality, whether the image adds sufficient image variety, and whether adding the image would result in a desired quantity of images for that item. If one or more such conditions are met, the image analysis system 104 may add the relevant new item image to the item image database 102.

In another example, the system 100 may be deployed at the entrance to a controlled-access facility to prevent introduction of prohibited items into the facility. A user may approach the entrance, which may have an NFC reader/scanner 108 for the user to scan an access badge. A CCTV camera 106 may be located in a fixed position above the entrance, with the NFC reader/scanner 108 and adjacent area (where the user and anything carried by the user will be) within the field of view 114 of the camera 106. When the user scans their access badge, the image analysis system 104 may receive the scan information, including the identity of the user and a time stamp of the scan. The image analysis system 104 may then retrieve the stream of video near in time to the time stamp and isolate one or more frames closest in time to the time stamp. In each isolated frame, the image analysis system may identify one or more items (e.g., each item identifiable in each image). Identified items may include, for example, dangerous items such as weapons and/or other items (e.g., cell phones and tablets, backpacks and other large bags, etc.) that may be prohibited by the facility.

The image analysis system 104 may compare the list of items identified in the isolated images to a list of prohibited items. If the image analysis system determines that the user possessed one or more prohibited items, the image analysis system 104 may output an alert. The alert may be to security personnel, for example, who may perform a follow-up inspection of the items and/or user. In some embodiments, the security personnel may respond to the alert by confirming or correcting, via a user computing device, the conclusions made by the image analysis system 104 as to the items possessed by the user. In some embodiments, the output alert may be automatically causing the access door to the facility to remain locked until the prohibited item is resolved by security personnel.

The image analysis system 104 may also consider each new item image in each isolated frame for addition to the item image library. For each new item image, the image analysis system 104 may determine whether the image is of sufficiently high quality, whether the image adds sufficient image variety, and whether adding the image would result in a desired quantity of images for that item. If one or more such conditions are met, the image analysis system 104 may add the relevant new item image to the item image database 102. In some embodiments, new item images may be added further in response to a security or other personnel confirming that the identification of the actual item by the image analysis system was correct.

In some embodiments, the image analysis system 104 may be site-specific, i.e., an instance of the image analysis system 104 may be deployed specifically in connection with a single facility or site with one or more cameras 106, one or more scanners 108, and one or more alert output mechanisms 112. In other embodiments, the image analysis system 104 may be deployed as a backend service for a plurality of sites or facilities. In such embodiments, the image analysis system 104 may communicate with a plurality of site-specific CCTV footage databases 110, or may communicate with a centralized CCTV footage database 110 that stores footage from multiple sites or facilities. Further, the image analysis system 104 may maintain a single item image library that is applied for all sites or facilities, or may maintain a plurality of respective site-specific item image libraries for the plurality of sites or facilities, with each such library containing images of items that are specific to that site, i.e., items that specifically are to be screened at that site, or images that specifically reflect the camera 106, lighting, or other image conditions of that site.

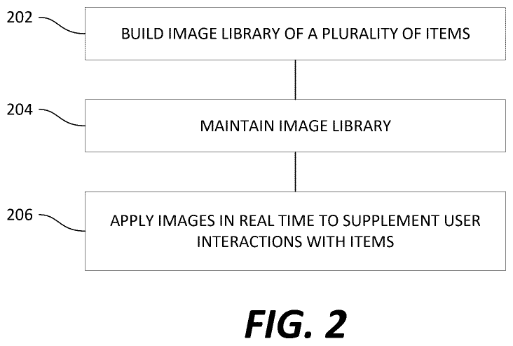

FIG. 2 is a flow chart illustrating an example method 200 of building and applying an item image library. The method 200, or one or more aspects of the method 200, may be performed by the image analysis system, and thus the method 200 may be computer-implemented.

The method 200 may include, at operation 202, building an image library of a plurality of items. Building the library at operation 202 may include an initial compilation of images of each of a plurality of items. The images may be of the item in their state expected at the time of user interaction, where that interaction will be monitored by video. For example, where the items are products in a retail environment, the images may be of the products as they would be presented at point-of-sale. Products may be in packaging, may be tagged and labelled, etc. Where items are packaged or otherwise presented in a variety of states or forms at the point of user interaction (e.g., an item may multiple physical configurations in addition to different types of packaging), the images may include each of those forms or states for each item.

The images may be of a similar quality to the quality that will be captured by a camera at the monitored point of user interaction. For example, the images may be from a CCTV or similar camera, where a CCTV camera will monitor the point of user interaction. The library of images may include a plurality of angles, lighting conditions, and other variations, for each item, that are expected to occur at the point of user interaction. The library of images may include greater than a minimum image threshold and less than a maximum image threshold quantity of images for each item.

The method 200 may further include, at operation 204, maintaining the image library, which may include adding new images to the library and removing old images from the library. Images may be added, as described herein, as those images are acquired during deployment of a system that uses the image library. For example, a new item image may be added to the library where it adds sufficient variety to the set of images of the item in the image. Accordingly, operation 204 may include comparing the new image to the set of images of the item in the library and adding the new item image to the library if it is sufficiently different from those images.

Maintaining the image library at operation 204 may be done for several purposes. First, as noted above, the image library may be supplemented to add to image variety and/or to achieve a quantity of images of an item between a minimum and maximum. Second, the image library may be supplemented if and when the outer appearance of the item changes, such as when new packaging, a new minor shape change or material change, or another change such that the appearance is different but the underlying item is the same. Maintaining the image library at operation 204 may include, for example, removing an image from the library if the image has not matched a captured item image in a threshold period of time, which may indicate that the item has had an outer appearance change and instances of the previous outer appearance are no longer in circulation or in use. Similarly, where no image of an item has matched a captured item image in a threshold period of time, which may indicate that the item is no longer in circulation or in use, all images of the item may be deleted from the library. In another example, maintaining the image library at operation 204 may include identifying and categorizing regional variations in item appearance (e.g., item packaging or labelling) or other variations from one site, or group of sites, to another site or group of sites. Item images may be labelled with the region or other group to which they belong, and those labels may be used to streamline image comparison during runtime. For example, when an item is detected in a live video or image, that item may be first compared to images specific to that region or site before other images in order to identify the item.

The method 200 may further include, at operation 206, applying the images of the image library in real time to supplement a user interaction with the items depicted in the item images. For example, operation 206 may include receiving an image or video stream substantially in real time, extracting item images in the image or video, comparing the extracted item images to the library of images to identify the items. The image or video stream may be captured by a camera at a point of user interaction with a plurality of items. Once the images are identified, operation 206 may include supplementing the user interaction. In some embodiments, operation 206 may include comparing the items to one or more lists or prohibited or permitted items, and outputting an alert to enable or prevent the user from bringing the items into, or taking items out of, a facility, for example.

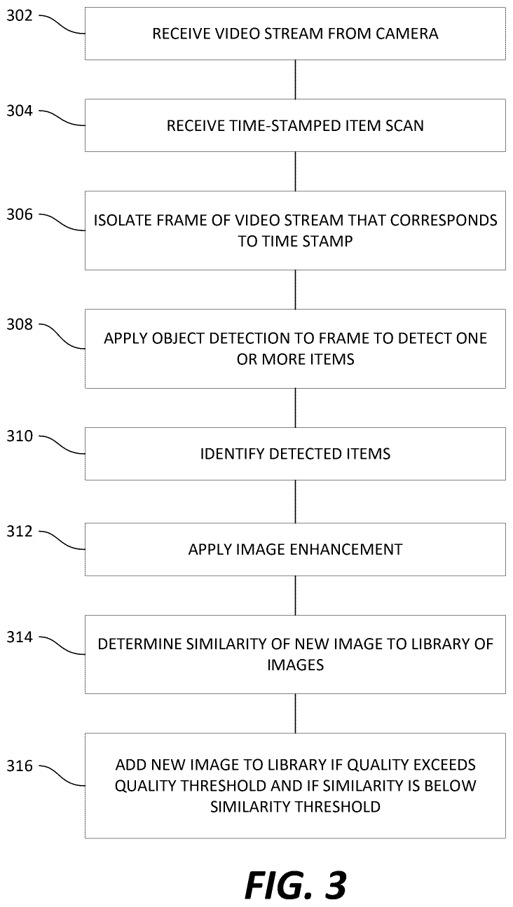

FIG. 3 is a flow chart illustrating an example method 300 of building an item image library. The method 300, or one or more aspects of the method 300, may be performed by the image analysis system, and thus the method 300 may be computer-implemented.

The method 300 may include, at operation 302, receiving a video stream from a camera. The camera may be a CCTV camera or other relatively low quality camera. The camera may be in a fixed position, in some embodiments. The camera may capture video within a field of view that includes a user point of interaction with one or more items. The field of view may also include the scanner or may be proximate to an item scanner such that the user is in the field of view when interacting with the item scanner.

The method 300 may further include, at operation 304, receiving a time-stamped item scan. The scan may include both a time stamp and an identity of the item scanned. The scan may be, for example, a bar code or QR code scan by a scanner within or proximate to the field of view of the camera.

The method 300 may further include, at operation 306, isolating one or more frames of the video stream that correspond to the time stamp. Operation 306 may include, for example, correlating respective time stamps of each frame of the video stream with the time stamp of the item scan. For example, the video frame closest in time to the item scan, based on correlation of time stamps, may be isolated. In some embodiments, a video frame that is a predetermined quantity of time before or after the item scan, based on time stamps, may be isolated. In some embodiments, operation 306 may include isolating a plurality of frames based on a single item scan, such as 2, 3, 4, or 5 frames, each of which may be analyzed as described herein.

In some embodiments, operation 306 may include searching video footage stored in a repository of such video, such as a storage of CCTV security footage for the facility. Operation 306 may include, therefore, identifying a video stream based on the identity of the scanner, based on a known association of a particular scanner to one or more particular cameras (and their video streams). For example, the repository may be or may include a SQL database and/or a cloud database, and operation 306 may include issuing a SQL command and/or issuing a retrieve command to a cloud service for retrieving, searching, or receiving the video stream, a frame of the video, and/or metadata associated with the video or one or more frames. In some embodiments, the video stream from a camera may be received live by a computing system performing the method 300, the computing system may store a short duration of such video, and operation 306 may include searching the locally-stored video.

In some embodiments, operation 306 may further include receiving or retrieving metadata associated with the scan and/or with the isolated video frame(s). For example, an item identifier as determined by the scan, a transaction identifier associated with the scan itself, and/or other information may be received or retrieved (along with the time stamps discussed above).

The method 300 may further include, at operation 308, applying one or more object detection algorithms to each isolated frame to detect one or more items in each frame. Operation 308 may include application of one or more fast object detection algorithms, such as You Only Look Once (YOLO). The object detection algorithm may, in addition to locating one or more identifiable objects in the frame, identify an item type for that object. In some embodiments, an object detection algorithm applied at operation 308 may be or may include a machine learning model trained on domain-specific item images to be able to detect items within images.

In some embodiments, operation 308 may include defining a respective bounding box for each identified object in the frame. The bounding box may be applied by the object detection algorithm noted above, or may be applied by an additional algorithm or model.

Operation 308 may include, in some embodiments, preprocessing a frame to enable more robust processing. Such preprocessing may include, for example, image resizing, scaling, rotation, smoothing, noise reduction, stabilization, etc. The preprocessing may be applied before the object detection and/or bounding box definitions, in some embodiments.

The method 300 may further include, at operation 310, identifying the one or more items detected in the item. Operation 310 may include associating an item detected in the image with the scan information, e.g., with the identity of the item indicated by the scan information. Where only a single item is detected in the image, that item may be associated with the scanned item identity. Where multiple items are detected in the image, operation 310 may include calculating the relative distances in each image of each item from the scanner and associating the closest item to the scanner with the scanned item identity.

Operation 310 may further include determining a representation of the detected item image that is consumable or processable by a machine learning model or other algorithm. For example, operation 310 may include determining a respective embeddings vector for each item detected in the image. A respective embeddings vector may be determined for each bounding box defined in the image, for example.

The representations of each detected item may be compared to stored representations in an item image library to identify each item. In some embodiments, for a given item image, the comparison may include calculating a distance between the embeddings vector respective of the item image and a plurality of embeddings vectors stored in the item image library. Operation 310 may include concluding that the item is the same as the closest embeddings vector in the item image library. In some embodiments, operation 310 may include comparing the distance between the item image embeddings vector and the closest embeddings vector in the library to a maximum distance threshold, determining that the distance is less than the maximum distance threshold and, in response, concluding that the item is the same as the closest embeddings vector in the item image library. Where the distance between the item image embeddings vector and the closest embeddings vector in the library is larger than the maximum distance threshold, the item image may not be identified, i.e., no conclusion may be reached for that particular item in that particular image.

For each identified item, operation 310 may further include cropping the image portion within the bounding box and converting the image portion into or otherwise defining the image portion as a new independent image, i.e., a new item image.

The method 300 may further include, at operation 312, applying one or more image enhancement techniques to each new item image and discarding low-quality images. The image enhancement techniques may include, for example, an image sharpness evaluation, such as a Variance of Laplacian (VOL) evaluation. Operation 312 may include applying an image sharpness algorithm (such as VOL) to the new item image to generate an image sharpness value (such as a VOL value). Operation 312 may further include comparing the image sharpness value to a minimum image sharpness threshold. When the image sharpness value is below the threshold, the new image may be discarded.

The image enhancement techniques may include, for example, a contrast improvement and evaluation technique, such as Contrast Limited Adaptive Histogram Equalization (CLAHE) Optimization or other histogram equalization. The contrast improvement technique may include adjusting the global contrast of the new item image by dividing the new item image into regions and applying histogram equalization within each region in order to improve the contrast of low-contrast image portions.

The contrast improvement technique may generate one or more values respective of contrast, such as an average contrast value among the regions of the image or other quantitative contrast representation. Operation 312 may further include comparing the contrast value(s) to a minimum contrast threshold. When a contrast value is below the threshold, the new item image may be discarded.

The image enhancement techniques may include, for example an image quality measurement that assesses the quality of the look and feel of the image, such as a Contrastive Language-Image Pre-training Image Quality Assessment (CLIP-IQA) value. The image quality measurement may include, for example, application of a neural network or other machine learning model trained to classify an image along several qualitative factors, where the training data includes user-generated judgments as to those qualitative properties of the image.

The image quality measurement may generate one or more values respective of image quality, such as a CLIP-IQA value. Operation 312 may further include comparing the image quality value(s) to a minimum quality threshold. When a quality value is below the threshold, the new item image may be discarded.

The method 300 may further include, at operation 314, determining a similarity of each image to each of a plurality of images of the same item in a library of images. Operation 314 may include, for example, generating an embeddings vector representative of the new item image after the processing at operation 312. In other embodiments, operation 314 may include using an embeddings vector representative of the new item image generated at operation 310. Operation 314 may include comparing the embeddings vector representative of the new item image to each embeddings vector of each image of that item that is stored in an item image library. For example, a respective distance of the new item image embeddings vector to each of the embeddings vectors for the item in the item image library may be calculated. If any of those distances is below a uniqueness or distance threshold, then the new item image may be discarded as too similar to an existing image, because adding such an image to the library may be redundant.

The method 300 may further include, at operation 316, adding a new image to the library if the quality of the image exceeds one or more of the quality thresholds (e.g., all of the quality thresholds) applied at operation 312 and if the similarity to other images is below a similarity threshold as determined at operation 314.

After being added to the item image library, the new item image may be applied for identification of items in CCTV and other video footage and images, for responsive action, as described herein.

Building and maintaining an item image library according to the present disclosure provides numerous benefits. For example, the teachings of the present disclosure may ensure that new images of an item add variety and value to the existing dataset. Additionally, by stopping adding new images of an item once enough images are available, the teachings of the present disclosure provide a robust item image comparison system without excessively large image storage. Additionally, by removing or avoiding adding duplicate images of an item based on similarity to existing images, the instant disclosure maintains a diverse and efficient dataset.

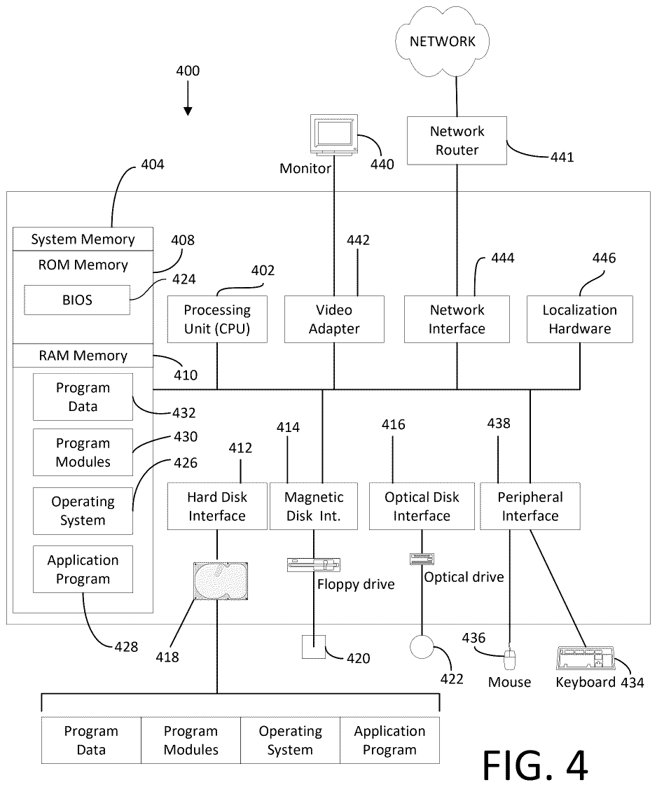

FIG. 4 is a diagrammatic view of an example embodiment of a user computing environment that includes a computing system environment 400, such as a desktop computer, laptop, smartphone, tablet, or any other such device having the ability to execute instructions, such as those stored within a non-transient, computer-readable medium. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 400 typically includes at least one processing unit 402 and at least one memory 404, which may be linked via a bus. Depending on the exact configuration and type of computing system environment, memory 404 may be volatile (such as RAM 410), non-volatile (such as ROM 408, flash memory, etc.) or some combination of the two. Computing system environment 400 may have additional features and/or functionality. For example, computing system environment 400 may also include additional storage (removable and/or non-removable) including, but not limited to, magnetic or optical disks, tape drives and/or flash drives. Such additional memory devices may be made accessible to the computing system environment 400 by means of, for example, a hard disk drive interface 412, a magnetic disk drive interface 414, and/or an optical disk drive interface 416. As will be understood, these devices, which would be linked to the system bus, respectively, allow for reading from and writing to a hard disk 418, reading from or writing to a removable magnetic disk 420, and/or for reading from or writing to a removable optical disk 422, such as a CD/DVD ROM or other optical media. The drive interfaces and their associated computer-readable media allow for the nonvolatile storage of computer readable instructions, data structures, program modules and other data for the computing system environment 400. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 400.

A number of program modules may be stored in one or more of the memory/media devices. For example, a basic input/output system (BIOS) 424, containing the basic routines that help to transfer information between elements within the computing system environment 400, such as during start-up, may be stored in ROM 408. Similarly, RAM 410, hard disk 418, and/or peripheral memory devices may be used to store computer executable instructions comprising an operating system 426, one or more applications programs 428 (which may include the functionality of the image analysis system 104 of FIG. 1 or one or more of its functional modules 124, 126, 128, 130, 132, for example), other program modules 430, and/or program data 432. Still further, computer-executable instructions may be downloaded to the computing environment 400 as needed, for example, via a network connection.

An end-user may enter commands and information into the computing system environment 400 through input devices such as a keyboard 434 and/or a pointing device 436. While not illustrated, other input devices may include a microphone, a joystick, a game pad, a scanner, etc. These and other input devices would typically be connected to the processing unit 402 by means of a peripheral interface 438 which, in turn, would be coupled to bus. Input devices may be directly or indirectly connected to processor 402 via interfaces such as, for example, a parallel port, game port, firewire, or a universal serial bus (USB). To view information from the computing system environment 400, a monitor 440 or other type of display device may also be connected to bus via an interface, such as via video adapter 442. In addition to the monitor 440, the computing system environment 400 may also include other peripheral output devices, not shown, such as speakers and printers.

The computing system environment 400 may also utilize logical connections to one or more computing system environments. Communications between the computing system environment 400 and the remote computing system environment may be exchanged via a further processing device, such a network router 441, that is responsible for network routing. Communications with the network router 441 may be performed via a network interface component 444. Thus, within such a networked environment, e.g., the Internet, World Wide Web, LAN, or other like type of wired or wireless network, it will be appreciated that program modules depicted relative to the computing system environment 400, or portions thereof, may be stored in the memory storage device(s) of the computing system environment 400.

The computing system environment 400 may also include localization hardware 446 for determining a location of the computing system environment 400. In embodiments, the localization hardware 446 may include, for example only, a GPS antenna, an RFID chip or reader, a WiFi antenna, or other computing hardware that may be used to capture or transmit signals that may be used to determine the location of the computing system environment 400.

The computing environment 400, or portions thereof, may include one or more components of the system 100 of FIG. 1, in embodiments.

In a first aspect of the present disclosure, a method is provided that includes receiving a new image of an item based on a time-stamped user interaction with the item, applying object detection to the new image to identify the item, determining a respective similarity of the image to each old image of the item in a library of old images, and determining that each respective similarity is below a similarity threshold and, in response, adding the new image to the library.

In an embodiment of the first aspect, determining the respective similarity includes generating a new embeddings vector representative of the new image, and comparing the new embeddings vector to a respective embeddings vector representative of each old image.

In an embodiment of the first aspect, the new image was captured by a closed-circuit television camera.

In an embodiment of the first aspect, the method further includes receiving a video stream, and isolating a frame of the video stream based on the time of the time-stamped user interaction with the item, wherein the isolated frame is the new image.

In an embodiment of the first aspect, the method further includes receiving, after adding the new image to the library, an image captured by a CCTV camera substantially in real time, the CCTV camera disposed at a facility, processing the new image to identify an item in the new image, and determining that the identified item in the new image is prohibited from entering or being removed from the facility and, in response, causing an alert to be output at the facility.

In an embodiment of the first aspect, the method further includes calculating a quality score for the new image, wherein adding the new image to the library is further responsive to the quality score exceeding a quality threshold. In a further embodiment of the first aspect, calculating the quality score includes one or more of calculating a variance of Laplacian (VOL) value, calculating a CLAHE optimization value, or calculating a CLIP-IQA value.

In a second aspect of the present disclosure, a system is provided that includes a fixed-position camera having a field of view, an item scanner disposed within the field of view, and a computing system in electronic communication with the camera and the scanner. The computing system includes a non-transitory, computer-readable memory and a processor configured to execute instructions stored in the memory to cause the computing system to perform operations including receiving a video stream from the camera, isolating a frame of the video stream based on a scan of an item by the scanner, applying object detection to the frame to identify a new item image in the frame, determining a respective similarity of the new item image to each old image of the item in a library of old images, and adding the new item image to the library only if each respective similarity is below a similarity threshold.

In an embodiment of the second aspect, isolating the frame of the video stream based on the scan of the item by the scanner includes determining a time stamp of the scan, and determining that the frame matches the time stamp and, in response, isolating the frame.

In an embodiment of the second aspect, the operations further include receiving, after adding the new image to the library, an image captured by a CCTV camera substantially in real time, the CCTV camera disposed at a facility, processing the new image to identify an item in the new image, and determining that the identified item in the new image is prohibited from entering or being removed from the facility and, in response, causing an alert to be output at the facility.

In an embodiment of the second aspect, the camera includes a closed-circuit television camera.

In an embodiment of the second aspect, the operations further includes calculating a quality score for the new item image, wherein adding the new item image to the library is further only if the quality score exceeds a quality threshold. In a further embodiment of the second aspect, calculating the quality score includes one or more of calculating a variance of Laplacian (VOL) value, calculating a CLAHE optimization value, or calculating a CLIP-IQA value.

In an embodiment of the second aspect, applying object detection to the frame is to identify a plurality of new item images of a plurality of items, and the operations further include determining, for each new item image of each item, a respective similarity of the new item image to each old image of the item in a library of old images, and adding the new item image to the library only if each respective similarity is below a similarity threshold.

In a third aspect of the present disclosure, a system is provided that includes a camera, and a computing system in electronic communication with the camera. The computing system includes a non-transitory, computer-readable memory and a processor configured to execute instructions stored in the memory to cause the computing system to perform operations including receiving a video stream from the camera, isolating a frame of the video stream based on a scan of an item by a scanner disposed in a field of view of the camera, applying object detection to the frame to identify a new item image in the frame, calculating a quality score for the new item image, and adding the new item image to a library of images of the item only if the quality score exceeds a quality threshold.

In an embodiment of the third aspect, the operations further include determining a respective similarity of the new item image to each old image of the item in the library of old images, and adding the new item image to the library only if each respective similarity is below a similarity threshold.

In an embodiment of the third aspect, the operations further include receiving, after adding the new image to the library, an image captured by a CCTV camera substantially in real time, the CCTV camera disposed at a facility, processing the new image to identify an item in the new image, and determining that the identified item in the new image is prohibited from entering or being removed from the facility and, in response, causing an alert to be output at the facility.

In an embodiment of the third aspect, the operations further include training an object detection model according to the library of images.

In an embodiment of the third aspect, the system further includes the item scanner.

In an embodiment of the third aspect, the camera is a low image quality camera

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed:

1. A method comprising:
receiving a new image of an item based on a time-stamped user interaction with the item;
applying object detection to the new image to identify the item;
determining a respective similarity of the image to each old image of the item in a library of old images; and
determining that each respective similarity is below a similarity threshold and, in response, adding the new image to the library.

2. The method of claim 1, wherein determining the respective similarity comprises:
generating a new embeddings vector representative of the new image; and
comparing the new embeddings vector to a respective embeddings vector representative of each old image.

3. The method of claim 1, wherein the new image was captured by a closed-circuit television camera.

4. The method of claim 1, further comprising:
receiving a video stream; and
isolating a frame of the video stream based on the time of the time-stamped user interaction with the item;
wherein the isolated frame is the new image.

5. The method of claim 1, further comprising:
receiving, after adding the new image to the library, an image captured by a CCTV camera substantially in real time, the CCTV camera disposed at a facility;
processing the new image to identify an item in the new image; and
determining that the identified item in the new image is prohibited from entering or being removed from the facility and, in response, causing an alert to be output at the facility.

6. The method of claim 1, further comprising:
calculating a quality score for the new image; and
wherein adding the new image to the library is further responsive to the quality score exceeding a quality threshold.

7. The method of claim 6, wherein calculating the quality score comprises one or more of:
calculating a variance of Laplacian (VOL) value;
calculating a CLAHE optimization value; or
calculating a CLIP-IQA value.

8. A system comprising:
a fixed-position camera having a field of view;
an item scanner disposed within the field of view; and
a computing system in electronic communication with the camera and the scanner, the computing system comprising a non-transitory, computer-readable memory and a processor configured to execute instructions stored in the memory to cause the computing system to perform operations comprising:
receiving a video stream from the camera;
isolating a frame of the video stream based on a scan of an item by the scanner;
applying object detection to the frame to identify a new item image in the frame; and
determining a respective similarity of the new item image to each old image of the item in a library of old images; and
adding the new item image to the library only if each respective similarity is below a similarity threshold.

9. The system of claim 8, wherein isolating the frame of the video stream based on the scan of the item by the scanner comprises:
determining a time stamp of the scan; and
determining that the frame matches the time stamp and, in response, isolating the frame.

10. The system of claim 8, wherein the operations further comprise:
receiving, after adding the new image to the library, an image captured by a CCTV camera substantially in real time, the CCTV camera disposed at a facility;
processing the new image to identify an item in the new image; and
determining that the identified item in the new image is prohibited from entering or being removed from the facility and, in response, causing an alert to be output at the facility.

11. The system of claim 8, wherein the camera comprises a closed-circuit television camera.

12. The system of claim 8, wherein the operations further comprise:
calculating a quality score for the new item image; and
wherein adding the new item image to the library is further only if the quality score exceeds a quality threshold.

13. The system of claim 12, wherein calculating the quality score comprises one or more of:
calculating a variance of Laplacian (VOL) value;
calculating a CLAHE optimization value; or
calculating a CLIP-IQA value.

14. The system of claim 8, wherein:
applying object detection to the frame is to identify a plurality of new item images of a plurality of items; and
the operations further comprise:
determining, for each new item image of each item, a respective similarity of the new item image to each old image of the item in a library of old images; and
adding the new item image to the library only if each respective similarity is below a similarity threshold.

15. A system comprising:
a camera; and
a computing system in electronic communication with the camera, the computing system comprising a non-transitory, computer-readable memory and a processor configured to execute instructions stored in the memory to cause the computing system to perform operations comprising:
receiving a video stream from the camera;
isolating a frame of the video stream based on a scan of an item by a scanner disposed in a field of view of the camera;
applying object detection to the frame to identify a new item image in the frame;
calculating a quality score for the new item image; and
adding the new item image to a library of images of the item only if the quality score exceeds a quality threshold.

16. The system of claim 15, wherein the operations further comprise:
determining a respective similarity of the new item image to each old image of the item in the library of old images; and
adding the new item image to the library only if each respective similarity is below a similarity threshold.

17. The system of claim 15, wherein the operations further comprise:
receiving, after adding the new image to the library, an image captured by a CCTV camera substantially in real time, the CCTV camera disposed at a facility;
processing the new image to identify an item in the new image; and
determining that the identified item in the new image is prohibited from entering or being removed from the facility and, in response, causing an alert to be output at the facility.

18. The system of claim 15, wherein the operations further comprise:
training an object detection model according to the library of images.

19. The system of claim 15, further comprising the item scanner.

20. The system of claim 15, wherein the camera is a low image quality camera.
